(19) United States
(12) Patent Application Publication
(10) Pub. No.: US 2002/0122145 A1
(43) Pub. Date: Sep. 5, 2002

(54) Method and apparatus of flicker reduction for LC shutter glasses

(76) Inventor: Carl Tung, Mohegan Lake, NY (US)

Correspondence Address: VRex, Inc., 85 Executive Blvd., Elmsford, NY, 10523, US

(21) Appl. No.: 10/055,481

(22) Filed: Jan. 23, 2002

Related U.S. Application Data
(60) Provisional application No. 60/263,402, filed on Jan. 23, 2001.

(51) Int. Cl. G02F 1/1335

(52) U.S. Cl. 349/96

(57) ABSTRACT

The preferred embodiment of the invention comprises a method of reducing flicker in a stereoscopic display system having LC shutter glasses and a display device, the glasses, having two LC shutter assemblies each having a first polarizing element nearer the eye, a second polarizing element nearer the display and an active rotator between the two polarizing elements. The method of reducing flicker comprises removing the second polarizing material from each LC shutter assembly and installing a third polarizing material in the optical path between said LC shutter glasses and said display device. The third polarizing material has a polarizing characteristics substantially identical to that of said second polarizing material. The display device is a CRT display, a front view projection system or a rear projection display screen wherein the third polarizing material is mounted on the rear projection screen between the projected image and the LC shutter glasses. A stereoscopic display system with reduce flicker using the method described above includes: LC shutter glasses having two LC shutter assemblies each having a first polarizing material nearer the eye and an active rotator; a display device; and, a second polarizing material in the optical path between said LC shutter glasses and said display device. The second polarizing material has a polarizing characteristic substantially orthogonal to that of said first polarizing material.

### BACKGROUND OF THE INVENTION

The present invention relates to a method and apparatus for flicker reduction when using liquid crystal shutter glasses while viewing three-dimensional imagery with a CRT monitor, or other display systems, particularly towards reducing the flicker perceived while viewing the non-display enviromnent.

The use of stereoscopic imaging in modem times has gained increasing popularity The reason for this trend in technological innovation is quite clear. At birth, each human being is endowed with the power of stereoscopic vision. It is this power alone that enables human beings to view the world, and all its inhabitants, in three dimensions with full depth perception.

Presently, there exist a number of known techniques for recording and displaying stereoscopic images of three-dimensional objects and scenery. In the art of video imaging, in particular, two principally different techniques are presently being used to record and display stereoscopic images. The first technique is commonly referred to as “time-multiplexed” or “field-sequential” stereo video or television, whereas the second technique is commonly referred to as “spatially multiplexed” stereo video or television.

In general, each of these stereo-imaging techniques involve image recording (i.e. generation) and image display processes. During the image generation process, left and right perspective images (or sequences of perspective images) of 3-D scenery are produced and subsequently recorded on a suitable recording medium. Notably, the recorded left and right perspective images are produced as if actually viewed with the inter-pupil distance of a human observer. Then, during the image display process, the visible light associated with the left and right perspective images is visually presented to the left and right eyes of viewers, respectively, while minimizing the amount of visible light from the left and right perspective images that impinge upon the right and left eyes of the viewer, respectively. As the left and right perspective images of the 3-D scenery are viewed by the left and right eyes of the viewer, 3-D stereoscopic image of the 3-D scenery is perceived, complete with full spatial and depth information of the actual 3˜D scenery.

The differences between the above-described techniques reside in the manner in which left and right perspective images are “channeled” to the left and right eyes of the viewer in order to preserve stereoscopy. These techniques will be briefly described below.

In 3-D video display systems based upon time-multiplexing principles, the left and the right perspective images of the 3-D scenery are displayed to viewers during different display periods (i.e. left and right perspective display periods). To ensure that only left perspective images of the 3-D scenery are presented to the left eye of viewers, the right eye of each viewer is not allowed to view the left perspective image during the left perspective image display period. Similarly, to ensure that only the right perspective images of the 3-D scenery are presented to the right eye of viewers, the left eye of each viewer is not allowed to view the right perspective image during the right perspective image display period. In the contemporary period, this perspective image “blocking,” or selective viewing process, is achieved using a pair of liquid crystal light valves (LQV) as the lenses in special eye wear (e.g. goggles) worn by each viewer using a 3-D image viewing system based on such principles. Typically, a controller is required in order to drive the left LCLV lens during each left perspective image display period and to drive the right LCLV lens during each right perspective image display period.

In 3-D video display systems based upon spatial-multiplexing principles, left and right perspective images of 3-D scenery are spatially multiplexed during the image generation process in order to produce a spatially multiplexed composite image. Then during the image display process, the visible light associated with the left and right perspective image components of the composite image are simultaneously displayed, but with spatially different “polarizations” imparted thereto. To ensure that only left perspective images of the 3-D scenery are presented to the left eye of viewers, the right eye of each viewer must not be allowed to view left perspective images. Similarly, to ensure that only the right perspective images of the 3-D scenery are presented to the right eye of viewers, the left eye of each viewer must not be allowed to view right perspective image. Typically, this perspective image “blocking.” or selective-viewing process, is achieved using a pair of spatially different polarizing lenses mounted in eye wear (e.g. spectacles) worn by each viewer using a 3-D video display system based on such principles of operation.

While each of these above-described 3-D image display techniques may be used to display 3-D color or gray-scale images, systems based on such techniques are not without shortcomings and drawbacks.

In particular, 3-D image display systems based upon time-multiplexing principles are plagued by “image flicker” problems. While 3-D video display systems based upon spatial-multiplexing principles are inherently free from the “image flicker” problem associated with time-multiplexed 3-D display systems, spatial-multiplexed 3-D display systems require the use of micropolarizers mounted onto display surfaces (e.g. CRT displays, flat panel liquid-crystal displays, light valve projectors, etc.) from which the polarized light of spatially-multiplexed images emanates. Consequently, this requirement necessitates specially manufactured display and projection surfaces, which in these particular applications can impose undesirable limitations upon the stereoscopic viewing process.

As an alternative to the above described 3-D image display systems and methods, U.S. Pat. No. 4,995.718 to Jachimowicz, et al. proposes a 3-D color video projection display system using spectral-multiplexing and light polarization principles. Similar to the above-described 3-D image display supports both image recording (i.e. generation) and display processes. However, unlike 3-D image display systems based upon time-multiplexing and spatial-multiplexing principles described above, the 3-D color projection display system of U.S. Pat. No. 4,995,718 exploits the spectral properties of both left and right perspective color images in order to ensure that only left right perspective color images of 3-D scenery are seen by the left and right eyes of viewers, respectively, during the image display process. Specifically, during the image generation process, left and right perspective color video images of 3-D scenery are recorded. During a first display period in the image projection process, the red and blue spectral components, (i.e. magenta), of the left perspective color image are imparted with a first light polarization state and then projected onto a display screen using a first image projector, while the green spectral components of the right perspective color image are imparted with a second light polarization state and projected onto the display screen using a second image projector. During the image projection process of the first display period, the separately projected left and right perspective images must be spatially superimposed, (i.e. aligned), in order that these differently polarized spectral components are recombined or “multiplexed” on the projection display screen, which is adapted to preserve the polarization states of the multiplexed spectral components. To ensure that only the magenta spectral components of the left perspective image are presented to the left eye of viewers during the first display period, while only the green spectral components of the right perspective image are presented to the right eye of viewers, the viewers are each required to wear spectacles having a left lens characterized by the first polarization state, and a right lens characterized by the second polarization state.

During a second display period in the image projection process, the green spectral components of the left perspective color image are imparted with a first light polarization state and then projected onto the display screen using the first image projector, while the magenta spectral components of the right perspective color image are imparted with a second light polarization state and then projected onto the display screen using the second image projector. During the second display period the separately projected left and right perspective images must be spatially superimposed (i.e. aligned) in order that these differently polarized spectral components are re-combined, (i.e. multiplexed), on the projection display screen. Also, the polarized spectacles worn by each viewer ensures that only the green spectral components of the left perspective image are visually presented to the left eye of viewers during the first display period, while only the magenta spectral components of the right perspective image are visually presented to the right eye of me viewers. As the projected spectrally multiplexed images are viewed by the viewers wearing the polarized spectacles during the first and the second display periods, a stereoscopic image of the 3-D scenery is perceived, complete with full spatial and depth information of the actual 3-D scenery.

While the 3-D color projection display system disclosed in U.S. Pat. No. 4,795,718 is capable of displaying 3-D stereoscopic color images of 3-D scenery objects and the like, this prior art system and stereoscopic display technique suffers from several significant shortcomings and drawbacks.

In particular, this prior art approach requires the use of three image projectors in order to project spectrally-filtered, polarized left and right images onto a display screen, upon which the polarized spectral components must recombine during each display period. Such image projection operations require multiple image projectors, a display screen, a large display viewing area and complicated optical signal processing equipment detailed in the Specification of U.S. Pat. No. 4,995,718.

The method of recording and processing left and right color images required by this prior 311 stereoscopic display method is generally incompatible with conventional television transmission and distribution schemes.

Moreover, when using this prior art display techniques, 3-D stereoscopic images cannot be “directly” viewed from CRT display surfaces, flat panel display surfaces, LCD display surfaces, plasma display panel surfaces, electro-luminescent panel display surfaces and the like.

A solution to many of these flicker problems was disclosed in U.S. Pat. No. 5,821.989 entitled “Stereoscopic 3-D viewing system and glasses having electro optical shutters controlled by control signals produced using horizontal pulse detection within the vertical synchronization pulse period of computer generated video signals” by Lazzaro et al. The Lazzaro disclosed provided a system in which lightweighted on a CRT computer or video display device according to the time-multiplexing display technique. The Lazzaro system is such that one shutter switches to the transmissive state while the other shutter switches to the opaque state synchronized to a specific field of information displayed on the CRT or display device. The shutter glasses disclosed by Lazzaro et al. have decoding circuitry which, when detecting no IR pulses, automatically enters a sleep mode or off sleep-state which will place both optical shutter glasses of Lazzaro view a very annoying level of flicker when viewing the non-display environment. This environment includes the walls, lights and other objects not part of the stereoscopic display to which the shutter glasses have a coordinated operation.

When LC shutter glasses open and close, the wear's eyes perceived some flicker on the CRT monitor which displays the field-sequential, (or page-flipped), image and perceived significant flicker from the environment surroundings the display device, depending upon the environment.

Thus, there is a great need in the art for an improved method and system for viewing stereoscopic images on a 3D display without the annoying flicker effects perceived while viewing the non-display environment.

Several patents and patent applications are representative of 3D display systems of stereoscopic images and make direct reference to the flicker problems in such systems. These include: U.S. Pat. Nos. 6,078,352, Stereoscopic viewing device and stereoscopic viewing method by Wakaya, et al.; 5,991,073, Autostereoscopic display including a viewing window that may receive black view data by Woodgate et al.; 5,907,364, Display device for information signals by Furuhata et al.; 5,821,989 ('989), Stereoscopic 3-D viewing system and glasses having electro optical shutters controlled by control signals produced using horizontal pulse detection within the vertical synchronizations pulse period of computer generated video signals by Lazzaro, et al.; 5,546,120 Autostereoscopic display system using shutter and back to back lenticular screen by Miller, et al. 5,510,832 Synthesized stereoscopic imaging system and method by Garcia, and 4,672,434 Stereoscopic television system and apparatus with 4 to 1 interlace display, all hereby incorporated by reference into this application.

### SUMMARY OF THE INVENTION

The preferred embodiment of the invention comprises a method of reducing flicker in a stereoscopic display system having LC shutter glasses and a display device, the glasses, having two LC shutter assemblies each having a first polarizing element nearer the eye, a second polarizing element nearer the display and an active rotator between the two polarizing elements. The method of reducing flicker comprises removing the second polarizing material from each LC shutter assembly and installing a third polarizing material in the optical path between said LC shutter glasses and said display device. The third polarizing material has a polarizing characteristics substantially identical to that of said second polarizing material. The display device is a CRT display, a front view projection system or a rear projection display screen wherein the third polarizing material is mounted on the rear projection screen between the projected image and the LC shutter glasses. A stereoscopic display system with reduce flicker using the method described above includes: LC shutter glasses having two LC shutter assemblies each having a first polarizing material nearer the eye and an active rotator; a display device; and, a second polarizing material in the optical path between said LC shutter glasses and said display device. The second polarizing material has a polarizing characteristic substantially orthogonal to that of said first polarizing material.

### BRIEF DESCRIPTION OF THE DRAWINGS

For a more complete understanding of the present invention, the detailed description of the Invention is to be read in conjunction with the following drawings, in which:

FIG. 1 illustrates a block diagram of a 3D system using LC shutter glasses;

FIG. 2 illustrates a block diagram of a preferred embodiment of the invention;

FIG. 3 illustrates a typical LC shutter operation in the ON state;

FIG. 4 illustrates a typical LC shutter operation in the off state; and

FIG. 5 illustrates the use of LC shutter glasses in stereoscopic visualization.

### DETAILED DESCRIPTION OF THE INVENTION

The preferred embodiment of the invention is a method and apparatus to reduce the total perceived flicker by eliminating perceived flicker from the environment surrounding the CRT monitor. The method, generally is to remove the polarizer, (closest to the CRT monitor), from each of the two LC shutters and put a polarizer, (of the same orientation as the ones removed), in front of the display device. This polarizer win serve the same function as the two polarizers removed from the LC shutter assembly. The result is that the perceived flicker will only appear on the monitor where the polarizer is.

Flicker from the shutter glasses results from the LC shutters opening and closing very rapidly in synchronization with a field sequential 3D stereo image displayed on a CRT monitor. As discussed above, the wearer sees a stereo image on the CRT monitor with some perception of flicker. However, there is much more perceived flicker, as the wearer looks aro 1.lnd the environment outside of the display device. The technique of the preferred embodiment eliminates the flicker outside of the display device, thus reducing the total perceived flicker when the wearer uses LC shutter glasses.

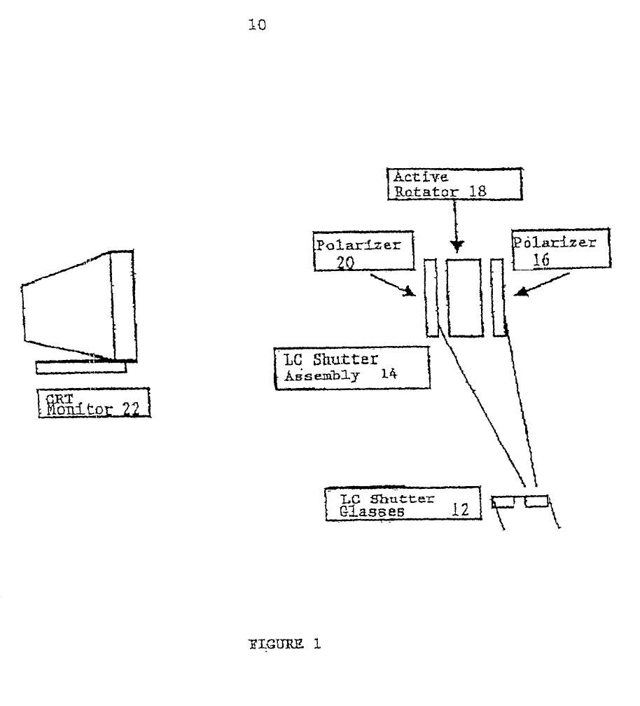

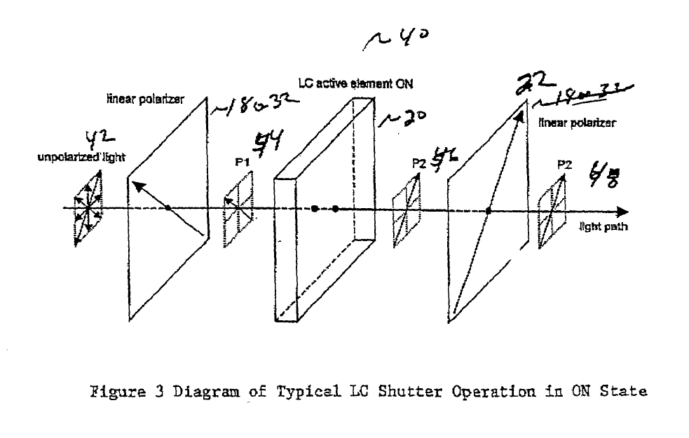

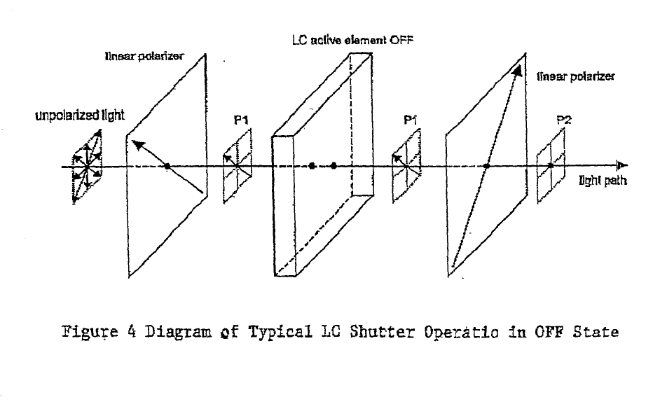

FIG. 1 illustrates a typical stereoscopic display system 10 using a CRT display 12 and LC shutter glasses 14. The LC shutter assembly 14 illustrates the typical structure of assembly of element in each eyepiece of an LC shutter assembly 16. First polarizer 18 provides a first angle of rotation as will be further illustrated in FIGS. 3 and 4. Active rotator 20 acts as on/off switch as further described below. The second polarizer 22 provides a second angle of rotation that is orthogonal to the first angle of rotation. The LC shutter glasses 14 comprise two LC shutter assemblies 16 a left eye and right eye assembly one of which is on and the other is off. The switching between the two LC shutter assemblies is coordinated with the display device 12 to produce a stereoscopic effect as discussed in the '989 patent by Lazzaro as well as elsewhere.

A user of the LC shutter glasses 14 with two LC shutter assemblies views the stereoscopic display with some very minimal flicker while viewing the display device 12.

However, if the user's view strays from the display device 12 providing a coordinated stereoscopic switched display to the other areas within the area in which the display is housed, the viewer is viewing walls, people and other objects that do not display the switched stereoscopic display. The user may sense significant flicker from the action of having each eye “shut-off” for the equivalent of the field time of the monitor's display. An exemplary time for the switching time is 1/60th of a second per eye. Higher rates of switching produce lower amounts of flicker perceived by the user.

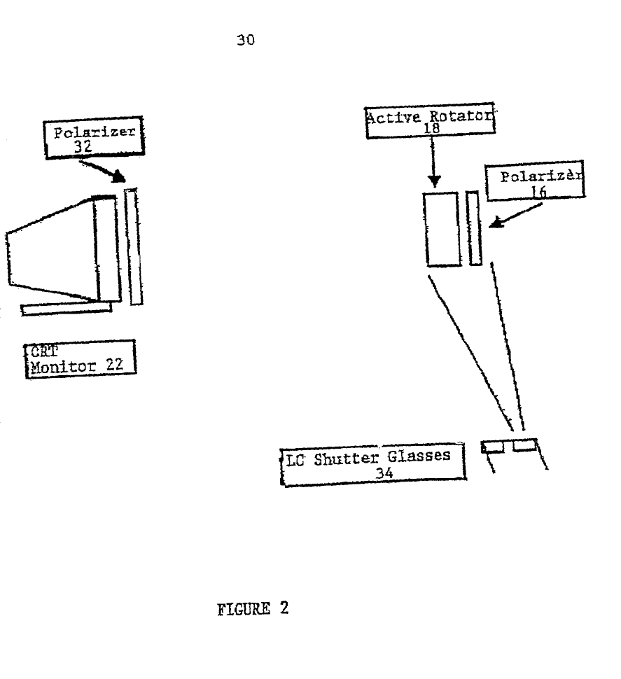

FIG. 2 illustrates the method and apparatus of a preferred embodiment of the invention 30. Elements of the invention common to more than one figure are numbered identically for clarity. The method conceptually involves using LC shutter glasses with only one polarizer and an active rotator. A single polarizer is placed either on the display device or in the optical path between the display device and the LC shutter glasses. The polarizer remaining in the shutter glasses uses the same polarization characteristics as the polarizer in FIG. 1 that is closest to the eye and is located on the eye side of the active rotator.

Each shutter assembly 36 includes an active rotator 20 and a polarizer 22 identical to the active rotator illustrated in FIG. 1. The polarization performed by the first polarizer 18 in FIG. 1 is accomplished by a single polarizer 32 installed on the display device 12 or within the optical path between the display device and the LC shutter glasses 34. Moving the polarization material from the position nearest the display on the LC shutter glasses to the display does not change the stereoscopic view to the viewer of the LC shutter glasses. However, the viewer does not see a switching ON/OFF of the shutter assemblies the when viewing the environment outside the display area. Since the viewer is not seeing any switching of the non-display environment, there is no flicker observed of the non-display environment.

To assist in the understanding of the operation of the polarization in the system, the operation of a typical liquid crystal shutter is illustrated in FIGS. 3 and 4. Typical LC shutters employ an active liquid crystal element sandwiched between two crossed polarizers as shown in the figures. The first linear polarizer 18, with the polarization labeled P1 44, polarizes light entering the shutter from the left (display device). The active shutter element has two possible states either ON or OFF. FIG. 3 shows the shutter in the ON state and FIG. 4 shows the shutter in the OFF state. In the ON state, the LC shutter passes polarized light by rotating the polarization angle 90° 46 parallel to the output polarizer 22. In The OFF state, the shutter blocks light by keeping the input polarization angle the same. Since the input polarization angle is orthogonal to the output polarizer, only a minimal amount of light is passed making the shutter appear dark.

In the exemplary embodiment the polarizer on the left, (input polarizer), polarizing the unpolarized light 32, is the polarization material located on or optically near the display device. As can be observed from a polarization point of view, the physical location of the input polarizer has no affect upon the operation of the stereoscopic viewing of the stereoscopic images on the display device.

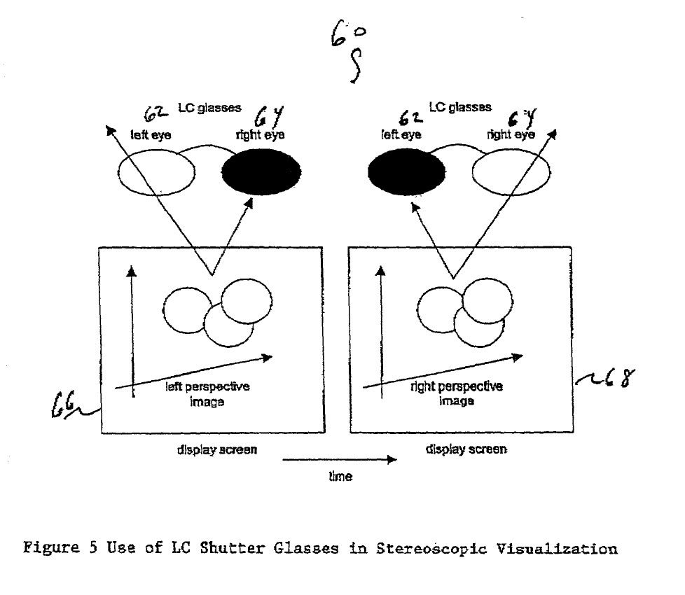

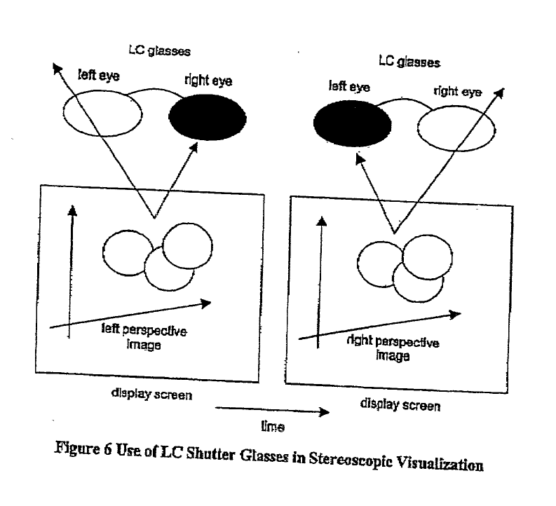

The use of liquid crystal shutter glasses for 3D stereoscopic viewing is illustrated in FIG. 5 60. A sequence of images that alternate between the left and right view perspective is displayed on a viewing screen. The screen is typically cathode ray tube (CRT)-based display, or a CRT-based projector. However, as will be discussed below, the display device may also be either a direct projection or rear projection device. Two shutters 62 and 64, serving as the primary optical components of the shutter glasses, are opened and closed so that the left eye shutter is open when the left eye image 66 is displayed and the right eye shutter is open when the right eye image 68 is displayed. When a shutter is closed, ideally all light is blocked from passing through the shutter element as shown in the figure. When the shutter is opened, the shutter is transparent allowing the underlying eye to see the intended image. FIG. 5 illustrates the transition from the left eye view to the right eye view from left to right with the left eye cycle on the left of the figure and the right eye cycle on the right of the figure. In the figure, time increases from left to right.

As discussed above, the display device may be a projection device as well as a direct view device. A front view projection device has the input polarization material 32 mounted at the output lens of the front projection device. A rear projection device may have the polarization material mounted at the output lens of the projector or as a piece of polarization material laminated to the projection screen.

The LC shutter glasses 34 of the preferred embodiment have only one polarization element as described above. However, it may be desirable: for the user to have multipurpose LC shutter glasses that incorporate the feature of LC shutter glasses 14 and the features of LC shutter glasses 34. In order to accomplish this, the LC shutter glasses may have a pair of fold-down polarization elements that swing up and down depending upon the location of their use. When a user is using a. display device having the input polarization material 32, the user swings up out of the optical path to the input portion of his/her LC shutter glasses containing the polarization element 18. When a user is using a display device not having an input polarization material 32, the users swings into the optical path the input portion of his/her LC shutter glasses containing polarization element 18. The swing. mechanically is similar to that used with moveable sunglasses. If the user uses the swing down operation when there is a polarizing material associated with the display device, there will be a slight drop in the brightness of the display as viewed by the user.

While the preferred embodiment has been described using linearly polarized material with each portion of the system the use of circularly polarized elements is equally useful. In such a system, the input linear polarizer 32 in the preferred embodiment, would be replaced by a passive circular polarizer. The LC shutter glass assemblies in the preferred embodiment would have, in addition to the active rotator 20 and the linear polarizer 22 (nearest the eye), a quarter wave element in the optical path at the location where the second polarizer existed in FIG. 1.

The present invention has been described in detail with reference to the above illustrative embodiments, however, modifications to the illustrative embodiments will readily occur to persons with ordinary skill in the art. All such modifications and variations are deemed to be within the scope and spirit of present inventions as defined by the accompanying claims to the invention.

What is claimed is:

1. A method of reducing flicker in a stereoscopic display system using LC shutter glasses, said method comprising:
using LC shutter glasses having two LC shutter assemblies each with only one polarizing material nearer the eye as a first palatalizing material and an active rotator nearer said display device; and
using a second polarizing material in the optical path between said LC shutter glasses and said display device.

2. The method of claim 1 wherein said second polarizing material has a polarizing characteristic substantially in quadrature from mat of said first polarizing material.

3. The method of claim 2 wherein said display device is from the group consisting of a direct view display a front view projection system and a rear projection display screen.

4. The method of claim 3 wherein when using said rear projection device, s.nd second polarizing material is mounted on said screen between said projected image and said LC shutter glasses.

5. A method of reducing flicker in a stereoscopic display system having LC shutter glasses and a display device said glasses having two LC shutter assemblies, each having a first polarizing material nearer the eye, a second polarizing material nearer the display and an active rotator, said method comprising;
removing said second polarizing material from each LC shutter assembly; and, installing a third polarizing material in the optical path between said LC shutter glasses and said display device.

6. The method of claim 5 wherein said third polarizing material has a polarizing characteristics substantially identical to that of said second polarizing material.

7. The method of claim 6 wherein said display device is from the group consisting of a CRT display, a LCD flat panel display or other flat direct view display device.

8. The method of claim 7 wherein said display device is a front view projection system.

9. The method of claim 8 wherein said display is a rear projection display screen and said third polarizing material is mounted on said screen between said projected image and said LC shutter glasses.

10. A stereoscopic display system with reduced flicker comprising: LC shutter glasses having two LC shutter assemblies each having a first polarizing material nearer the eye and an active rotator; a display device; and a second polarizing material in the optical path between said LC shutter glasses and said display device

11. The system of claim 10 wherein said second polarizing material has a polarizing characteristic substantially orthogonal to that of said first polarizing material.
